(19) United States
(12) Patent Application Publication
(10) Pub. No.: US 2020/0311884 A1
(43) Pub. Date: Oct. 1, 2020

(54) METHOD AND APPARATUS FOR GENERATING VIRTUAL REALITY IMAGE INSIDE VEHICLE USING IMAGE STITCHING TECHNIQUE

(71) Applicant: The Hong Inc., Seoul (KR)

(72) Inventors: Youn Jung HONG, Seoul (KR); Young Jong LEE, Seoul (KR)

(21) Appl. No.: 16/829,821

(22) Filed: Mar. 25, 2020

(30) Foreign Application Priority Data
Mar. 27, 2019 (KR) 10-2019-0035186

(51) Int. Cl. G06T 5/00; G06T 3/40

(52) U.S. Cl. CPC G06T 5/005; G06T 2207/10024; G06T 3/4038

(57) ABSTRACT

A method of operating a terminal performing image stitching to generate a virtual reality (VR) image inside a vehicle may comprise obtaining a plurality of images including a first image and a second image; generating a corrected first image and a corrected second image based on the first image and the second image; setting a stitching region, which is a preset region and includes a plurality of pixels, in the corrected first image and obtaining information on the plurality of pixels included in the stitching region; searching a region corresponding to the stitching region from the corrected second image based on the information on the plurality of pixels included in the stitching region; and stitching a region of the corrected second image excluding the corresponding region onto the corrected first image.

### CROSS-REFERENCE TO RELATED APPLICATIONS

This application claims priority to Korean Patent Applications No. 10-2019-0035186 filed on Mar. 27, 2019 with the Korean Intellectual Property Office (KIPO), the entire contents of which are hereby incorporated by reference.

### BACKGROUND

### 1. Technical Field

Exemplary embodiments of the present invention relate in general to a method of stitching images, and more specifically, to a method of generating a virtual reality (VR) image inside a vehicle by correcting color information of boundary surfaces between a plurality of obtained images and stitching the images based on the corrected color information.

### 2. Related Art

Virtual reality (VR) refers to an interface between a user and a device that makes it possible for a person using particular environments or situations created by a computer to feel as if he or she is interacting with real environments and situations. VR technology allows the user to feel realism through manipulated sensory stimuli and may be utilized in many industrial fields such as a game field, an education field, a medical field, and journalism.

Recently, as people's interest in VR increases, the development of techniques for implementing the VR has been actively performed. In particular, research on techniques for processing images constituting a virtual space necessary for implementing the VR has been actively conducted. With the development of techniques related to VR images, a user may watch 360-degree video as well as a planar video through panoramic images.

A panoramic image may refer to an image in which a plurality of images are combined horizontally (a left side and a right side) to cover a horizontal viewing angle of 180 to 360 degrees. A 360-degree image may refer to an image that may cover all of the upper, lower, left, and right sides around a user and may generally be obtained by placing multiple images on a sphere or Mercator.

However, in order to obtain such a panoramic image or 360-degree image, specialized equipment is required. Recently, there has been a trial in which a user directly carries a mobile terminal (e.g., a smartphone), rotates the mobile terminal around the user to obtain a plurality of pictures, and matches the obtained pictures to generate a matched image (e.g., a panoramic image or a 360-degree image).

However, in such a case, the viewing angle or capturing direction of each of the plurality of pictures is not accurate, and thus not only does it take considerable time to stitch images but also the accuracy of stitching is low.

### SUMMARY

Accordingly, exemplary embodiments of the present invention are provided to substantially obviate one or more problems due to limitations and disadvantages of the related art.

Exemplary embodiments of the present invention provide a method and apparatus for correcting each of images captured inside a room based on luminance information and stitching the images based on color information of the corrected images.

According to an exemplary embodiment of the present disclosure, a method of operating a terminal performing image stitching may comprise obtaining a plurality of images including a first image and a second image; generating a corrected first image and a corrected second image based on the first image and the second image; setting a stitching region, which is a preset region and includes a plurality of pixels, in the corrected first image and obtaining information on the plurality of pixels included in the stitching region; searching a region corresponding to the stitching region from the corrected second image based on the information on the plurality of pixels included in the stitching region; and stitching a region of the corrected second image excluding the corresponding region onto the corrected first image.

The plurality of images may be images captured by a fisheye lens, and the generating of the corrected first image and the corrected second image may include correcting color information of pixels included in the first image and the second image.

The searching of the region corresponding to the stitching region from the corrected second image may include searching for a region in which a ratio of pixels corresponding to color information of the pixels included in the stitching region exceeds a preset range from the corrected second image.

The searching of the region corresponding to the stitching region from the corrected second image may include searching for a region, which includes pixels having color information whose error rate does not exceed a preset range as compared with the pixels included in the preset region of the first image, from the corrected second image.

The method may further comprise, after the searching of the region corresponding to the stitching region from the corrected second image, calculating an average of error rates between the color information of the pixels included in the preset region of the first image and color information of pixels included in a region of the second image to be overlapped; and correcting a color of the second image based on the average value of the error rates.

The method may further comprise, when the corresponding region is not searched in the searching of the region corresponding to the stitching region from the corrected second image, obtaining a third image; generating a corrected third image based on the third image; searching a region corresponding to the stitching region from the corrected third image based on pixel information on the preset region of the corrected first image; and stitching a region of the corrected third image excluding the corresponding region onto the corrected first image.

The third image may be an image captured at a position between a position of a camera at which the first image is captured and a position of a camera at which the second image is captured.

According to another exemplary embodiment of the present disclosure, a terminal for performing image stitching to generate a virtual reality (VR) image inside a vehicle may comprise a processor; and a memory in which at least one command to be executed by the processor is stored, wherein the at least one command is executed to: obtain a plurality of images including a first image and a second image; generate a corrected first image and a corrected second image based on the first image and the second image; set a stitching region, which is a preset region and includes a plurality of pixels, in the corrected first image; obtain information on the plurality of pixels included in the stitching region; search for a region corresponding to the stitching region from the corrected second image based on the information on the plurality of pixels included in the stitching region; and stitch a region of the corrected second image, which excludes the corresponding region, onto the corrected first image.

The plurality of images may be images captured by a fisheye lens, and the at least one command may be further executed to correct colors of pixels included in the first image and the second image.

The at least one command may be executed to search for a region in which a ratio of pixels corresponding to color information of the pixels included in the stitching region exceeds a preset range from the corrected second image.

The at least one command may be executed to search for a region, which includes pixels having color information whose error rate does not exceed a preset range as compared with the pixels included in the preset region of the first image, from the corrected second image.

The at least one command may be further executed to: after being executed to search for the region corresponding to the stitching region from the corrected second image, calculate an average of error rates between the color information of the pixels included in the preset region of the first image and color information of pixels included in a region of the second image to be overlapped; and correct a color of the second image based on the average of the error rates.

The at least one command may be further executed to, when the corresponding region is not searched from the corrected second image, obtain a third image; generate a corrected third image based on the third image; search for a region corresponding to the stitching region from the corrected third image based on pixel information of the preset region of the corrected first image; and stitch a region of the corrected third image excluding the corresponding region onto the corrected first image.

The third image may be an image captured at a position between a position of a camera at which the first image is captured and a position of a camera at which the second image is captured.

According to the present invention, by stitching a plurality of images based on the color information of the images corrected based on the luminance information of the pixels included in the images, the plurality of images can be smoothly stitched.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a block diagram illustrating a first example embodiment of a structure of a terminal;

FIG. 2 is a flowchart illustrating one example embodiment of an image stitching operation of the terminal;

FIG. 3 is a conceptual diagram illustrating one example embodiment of a result of performing an image correction operation of the terminal;

FIG. 4 is a conceptual diagram illustrating one example embodiment of a first image, a second image, and a stitched image;

FIG. 5 is a flowchart illustrating a second example embodiment of an image stitching operation of the terminal;

FIG. 6 is a block diagram illustrating one example embodiment of a result of capturing a first image and a second image inside a room;

FIG. 7 is a block diagram illustrating one example embodiment of a result of capturing a first image, a second image, and a third image inside a room; and

FIG. 8 is a conceptual diagram illustrating one example embodiment of a first image, a second image, a third image, and a stitched image.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

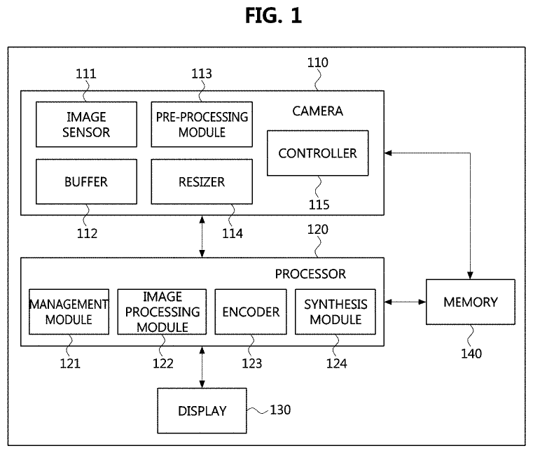

FIG. 1 is a block diagram illustrating a first example embodiment of a structure of a terminal.

Referring to FIG. 1, the terminal may include a camera 110, a processor 120, a display 130, and a memory 140. The camera 110 may include an image sensor 111, a buffer 112, a pre-processing module 113, a resizer 114, and a controller 115. The camera 110 may obtain images of an external area. The camera 110 may store raw data generated by the image sensor 111 in the buffer 112 of the camera. The raw data may be processed by the controller 115 in the camera 110 or the processor 120. The processed data may be transmitted to a memory 140 or an encoder 123. Alternatively, the raw data may be processed and then stored in the buffer 112 and transmitted from the buffer 112 to the memory 140 or the encoder 123. The camera 110 may include a fisheye lens, and the image obtained by the camera 110 may be an equirectangular image, a panoramic image, a circular fisheye image, a spherical image, or a portion of a three-dimensional (3D) image.

The image sensor 111 may collect the raw data by sensing the light incident from the outside. The image sensor 111 may include at least one among, for example, a charge-coupled device (CCD), a complementary metal-oxide semiconductor (CMOS) image sensor, or an infrared (IR) light sensor. The image sensor 111 may be controlled by the controller 115.

The pre-processing module 113 may convert the raw data obtained by the image sensor 111 into a color space format. The color space may be one of a YUV color space, a red-green-blue (RGB) color space, and a red-green-blue-alpha (RGBA) color space. The pre-processing module 113 may transmit the data converted into the color space format to the buffer 112 or the processor 120.

The pre-processing module 113 may correct an error or distortion of an image included in the received raw data. In addition, the pre-processing module 113 may adjust the color or size of the image included in the raw data. The pre-processing module 113 may perform at least one operation among, for example, bad pixel correction (BPC), lens shading, demosaicing, white balance (WB), gamma correction, color space conversion (CSC), HSC (hue, saturation, and contrast) improvement, size conversion, filtering, and image analysis.

The processor 120 of the terminal may include a management module 121, an image processing module 122, the encoder 123, and a synthesis module 124. The management module 121, the image processing module 122, the encoder 123, and the synthesis module 124 may be hardware modules included in the processor 120 and may be software modules that may be executed by the processor 120. Referring to FIG. 1, the management module 121, the image processing module 122, the encoder 123, and the synthesis module 124 are illustrated as being included in the processor 120, but the present invention may not be limited thereto. Some portions of the management module 121, the image processing module 122, the encoder 123, and the synthesis module 124 may be implemented as separate modules from the processor 120.

According to one example embodiment, the management module 121 may control the camera 110 included in the terminal. The management module 121 may control an initialization, a power input mode, and an operation of the camera 110. In addition, the management module 121 may control an operation of processing the image of the buffer 112 included in the camera 110, captured image processing, the size of the image, and the like.

The management module 121 may control a first electronic device (not shown) to adjust auto focus, auto exposure, resolution, bit rate, frame rate, camera power mode, vertical blanking interval (VBI), zoom, gamma or white balance, and the like. The management module 121 may transmit the obtained image to the image processing module 122 and control the image processing module 122 to perform processing.

The management module 121 may transmit the obtained image to the encoder 123. In addition, the management module 121 may control the encoder 123 to encode the obtained image. The management module 121 may transmit a plurality of images to the synthesis module 124 and control the synthesis module 124 to synthesize the plurality of images.

The image processing module 122 may obtain the image from the management module 121. The image processing module 122 may perform an operation of processing the obtained image. Specifically, the image processing module 122 may perform noise reduction, filtering, image synthesis, color correction, color conversion, image transformation, 3D modeling, image drawing, augmented reality (AR)/virtual reality (VR) processing, dynamic range adjusting, perspective adjustment, shearing, resizing, edge extraction, region of interest (ROI) determination, image matching and/or image segmentation of the obtained image. The image processing module 122 may perform processing such as synthesizing the plurality of images, generating a stereoscopic image, or a panoramic image based on depth.

The synthesis module 124 may synthesize the images. The synthesis module 124 may perform synthesizing, transparency processing, layer processing, and the like of the images. The synthesis module 124 may also stitch the plurality of images. For example, the synthesis module 124 may stitch a plurality of images obtained by the camera 110 and may also stitch a plurality of images received from a separate device. The synthesis module 124 may be included in the image processing module 122.

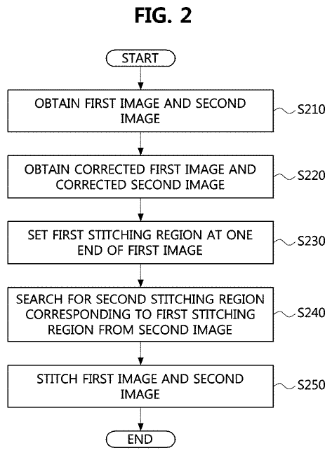

FIG. 2 is a flowchart illustrating one example embodiment of an image stitching operation of the terminal.

Referring to FIG. 2, a terminal 100 may obtain a plurality of images including a first image and a second image through the camera 110 device. Alternatively, the terminal may obtain the first image and the second image from the camera device outside the terminal (S210). The terminal may correct the plurality of obtained images based on a preset algorithm to obtain the corrected images (S220).

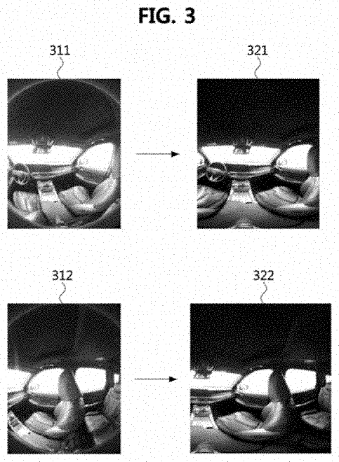

FIG. 3 is a conceptual diagram illustrating one example embodiment of a result of performing an image correction operation of the terminal.

Referring to FIG. 3, the terminal may obtain a first image 311 and a second image 312. For example, the terminal may obtain the images 311 and 312 captured by a fisheye lens as illustrated in FIG. 3. The first image 311 and the second image 312 may be circular images. Although the first image 311 and the second image 312 are illustrated in FIG. 3 as being circular images, the first image 311 and the second image 312 may be rectangular images projected onto a rectangular-shaped area. When the angle of view of a camera included in the terminal is greater than or equal to 180°, a partial region of the first image 311 and a partial region of the second image 312 may be regions including an image of the same subject. The terminal may process the first image 311 and the second image 312 to generate a corrected first image 321 and a corrected second image 322 (S220).

The terminal may stitch the first image 311 and the second image 312 to generate an omnidirectional image for mapping the first image 311 and the second image 312 to a spherical virtual model. For example, the omnidirectional image may be a rectangular image and an image for hexahedral mapping.

Specifically, the terminal 100 may obtain an image of a peripheral region of each of the first image 311 and the second image 312. The terminal may perform an image processing operation on the image corresponding to the peripheral region.

The terminal may obtain an image corresponding to a central region of each of the plurality of images excluding the peripheral region. When the first image 311 and the second image 312 are stitched to generate the omnidirectional image, the partial region of the first image 311 and the partial region of the second image 312 may overlap each other. In order to generate the omnidirectional image, the terminal may perform image processing on the partial region of the first image 311 and the partial region of the second image 312 using various techniques, such as a key-point detection technique, an alignment technique, or a blending technique.

According to one example embodiment, the terminal may adjust the resolution of images corresponding to peripheral regions 712 and 722 of the first image and the second image or the resolution of images corresponding to central regions 711 and 721 of the first image and the second image such that the resolution of the images corresponding to the peripheral regions 712 and 722 is greater than the resolution of the images corresponding to the central regions 711 and 721. For example, when the resolution of the peripheral regions 712 and 722 is low and thus it is difficult to perform stitching, a first electronic device or a second electronic device may perform processing to increase the resolution of the peripheral regions 712 and 722.

According to one example embodiment, the terminal may adjust a frame rate of the images corresponding to the peripheral regions of the first image and the second image or a frame rate of the images corresponding to the central regions of the first image and the second image so that the frame rate of the images corresponding to the peripheral regions is less than the frame rate of the image corresponding to the central regions. For example, when the movement of the camera or subject is small, the terminal may reduce the frame rate of the partial region of each of the first image and the second image to reduce the amount of computation. For example, when a subject of the central region of the first image 311 moves and a subject of the peripheral region of the first image does not move, the terminal may reduce the frame rate of the peripheral region of the first image.

The terminal may encode the first image and the second image according to the adjusted frame rate. For example, the first electronic device or the second electronic device may encode the central regions 711 and 721 of the first image and the second image at a relatively high frame rate and encode the peripheral regions 712 and 722 of the first image and the second image at a relatively low frame rate to generate the corrected first image and the corrected second image (S220).

The terminal may obtain luminance information on the peripheral region of each of the plurality of images. The terminal may correct the first image and the second image based on the luminance information of each of the first and second images to generate the corrected images (S220).

Referring to FIG. 2 again, the terminal may set a preset range of region at one end portion of the corrected first image as a first stitching region (S230). The terminal may obtain information on a plurality of pixels included in the first stitching region. For example, the terminal may obtain a pixel ID, color information, or the like of each of the plurality of pixels included in the first stitching region.

The terminal may search for a region corresponding to the first stitching region of the first image among the corrected second image (S240). The region corresponding to the first stitching region may be defined as a second stitching region. The terminal may search for the second stitching region among the second image based on the information on the plurality of pixels included in the first stitching region (S240).

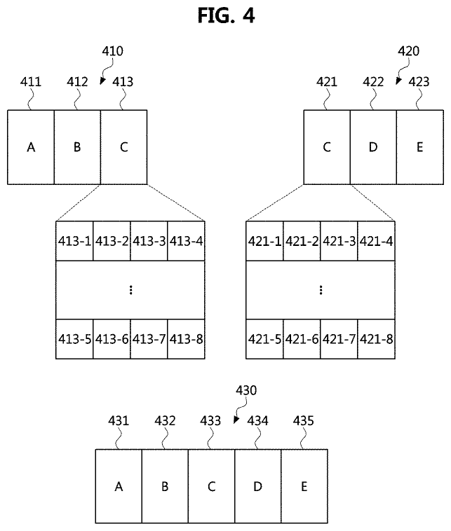

FIG. 4 is a conceptual diagram illustrating one example embodiment of a first image, a second image, and a stitched image.

Referring to FIG. 4, a first stitching region 413 of a first image 410 may be located at one end on the right side of the first image 410. The stitching region of the first image may include a plurality of pixels 413-1, . . . , and 413-8. In addition, a second image 420 may include a second stitching region 421 corresponding to the first stitching region 413 of the first image. The second stitching region 421 may be located at one end on the left side of the second image 420. The second stitching region 421 may include a plurality of pixels 421-1, . . . , and 421-8. The number of the plurality of pixels 421-1, . . . , and 421-8 included in the second stitching region may be equal to the number of the pixels 413-1, . . . , and 413-8 included in the first stitching region 413 of the first image.

In order to search for a region corresponding to the first stitching region 413 of the first image 410 from the second image 420, which is a corrected image, the terminal may search for a region in which the ratio of the pixels corresponding to color information of the pixels included in the first stitching region 413 exceeds a preset range (S240).

Specifically, the terminal may compare the color information of the pixels included in the stitching region of the first image with color information of the pixels of the second image. For example, the terminal may compare color information of a first pixel 413-1 of the stitching region of the first image with color information of a pixel 421-1 of the second image and compare color information of an eighth pixel 413-8 of the stitching region of the first image with color information of a pixel 421-8 of the second image. The terminal may determine whether the color information of the pixels of the region included in the second image matches the color information of the pixels included in the stitching region of the first image.

The terminal may calculate a matching rate between the pixel information of the region included in the second image 420 and the pixel information of the stitching region 413 included in the first image 410. In addition, when the matching rate between the pixel information of the region included in the second image 420 and the pixel information of the stitching region 413 included in the first image 410 exceeds a preset range, the terminal may determine the region included in the second image 420 as the second stitching region 421 corresponding to the first stitching region 413 of the first image 410 (S240).

For example, when the color information of at least 90% of the pixels included in the partial region of the second image 420 matches the color information of the pixels included in the stitching region of the first image, the terminal may determine the partial region of the second image as the region corresponding to the stitching region (S240).

Alternatively, in order to search for the region corresponding to the first stitching region 413 of the first image 410 from the corrected second image 420, the terminal may search for a region that includes pixels having color information whose error rate does not exceed a preset range (S240).

Specifically, the terminal may compare the color information of the pixels included in the first stitching region 413 of the first image 410 with the color information of the pixels of the second image 420. For example, the terminal may compare the color information of the first pixel 413-1 of the first stitching region 413 of the first image 410 with the color information of the pixel 421-1 of the second image and compare the color information of the eighth pixel 413-8 of the stitching region with the color information of the pixel 421-8 of the second image. The terminal may calculate an error rate of each of the pixels included in the second image.

The terminal may calculate an error rate of each of the pixels included in the partial region of the second image 420. In addition, when the error rates of the pixels included in the partial region of the second image 420 are within a preset range, the terminal may determine the partial region of the second image 420 as the second stitching region 421 corresponding to the first stitching region 413 of the first image 410 (S240).

For example, when the error rates of all the pixels included in the partial region of the second image 420 are within 10%, the terminal may determine the partial region of the second image 420 as the second stitching region 421 corresponding to the first stitching region 413 of the first image 410 (S240).

The terminal may stitch the first image 410 and the second image 420. Specifically, the terminal may stitch the second image 420 onto the stitching region 413 of the first image 410 and stitch the remaining regions 422 and 423 of the second image 420 excluding the second stitching region 421 onto the first image 410.

The terminal may further correct the second image 420 and stitch the corrected second image 420 onto the first image. For example, when the error rate of the second stitching region 421 of the second image 420 is within a preset range, the terminal may correct the remaining regions 422 and 423 of the second image based on the error rate of the pixels included in the second stitching region 421. Specifically, the terminal may calculate an average value of error rates of the pixels 421-1, . . . , and 421-8 included in the second stitching region 421 of the second image 420 and may correct colors of the pixels included in the remaining regions 422 and 423 of the second image excluding the second stitching region 421 using the average value of the error rates. The terminal may stitch the second image 420 having the corrected colors onto the first stitching region 413 of the first image 410 (S250).

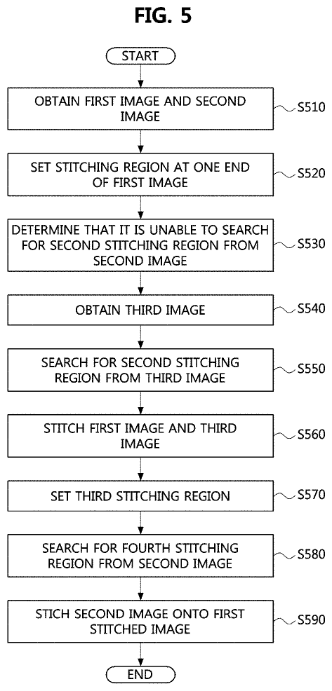

FIG. 5 is a flowchart illustrating a second example embodiment of an image stitching operation of the terminal.

Referring to FIG. 5, the terminal may obtain a first image and a second image (S510). The terminal may set a partial region of a first image 631 as a first stitching region (S520), and specifically, may set a region C (623), which is one end on the right side of the first image 631, as the first stitching region (S520). The terminal may search for a region corresponding to the first stitching region 623 of the first image 631 among a second image 632 (S510). When the terminal fails to search for the region corresponding to the first stitching region 623 of the first image 631 among the second images 632 (S530), the terminal may additionally obtain a third image (S540).

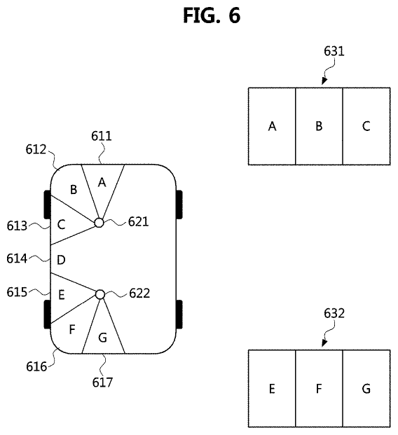

FIG. 6 is a block diagram illustrating one example embodiment of a result of capturing a first image and a second image inside a room.

Referring to FIG. 6, each lens of a camera capturing an image may capture images of an area included in an angle of view thereof. For example, a camera, which captures an interior of a room at a first position 611, may capture regions A (621), B (622), and C (623). In addition, the camera, which captures the interior of a room at a second position 612, may capture regions E (625), F (626), and G (627). Thus, the first image 631 may include images of regions A (621), B (622), and C (623), and the second image 632 may include images of regions E (625), F (626), and G (627). According to the example embodiment described with reference FIG. 6, the terminal may be unable to stitch the first image 631 and the second image 632 and may obtain a third image that is an image stitched between the first image 631 and the second image 632 (S540).

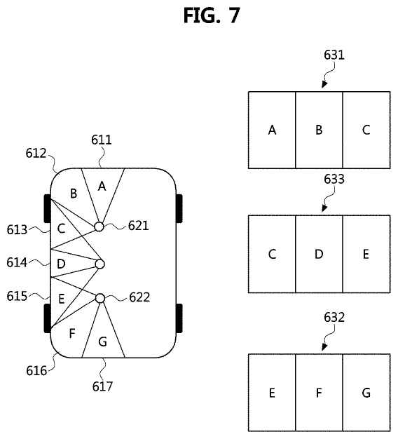

FIG. 7 is a block diagram illustrating one example embodiment of a result of capturing a first image, a second image, and a third image inside a room.

Referring to FIG. 7, a third image 633 may be an image captured by the same camera that captured the first image 631 and the second image 632. In addition, the third image 633 may be an image captured at a position 613 between the position 611 of the camera at which the first image 631 is captured and the position 612 of the camera at which the second image is captured. Accordingly, the third image 633 may capture an image of a section between the first image 631 and the second image 632. For example, the third image 633 may be an image that includes regions C (613), D (624), and E (625). Thus, when the first to third images are stitched, a continuous image from the region A to the region G may be generated. The heights of the camera at which the first to third images are captured may be the same.

Referring to FIG. 5 again, the terminal may correct the obtained third image using a preset algorithm to generate a corrected third image. For example, the terminal may correct the resolution, frame rate, luminance, and the like of the third image to generate the corrected third image. The terminal may search for a second stitching region corresponding to the first stitching region of the first image from the corrected third image (S550).

In order to search for the second stitching region corresponding to the stitching region of the first image from the corrected third image, the terminal may search for a region in which the ratio of pixels corresponding to the color information of the pixels included in the first stitching region exceeds a preset range (S550). Alternatively, in order to search for the region corresponding to the first stitching region of the first image from the corrected third image, the terminal may search for a region including pixels having color information whose error rate does not exceed a preset range (S550). The terminal that has searched for the second stitching region from the third image may stitch the first image and the third image (S560).

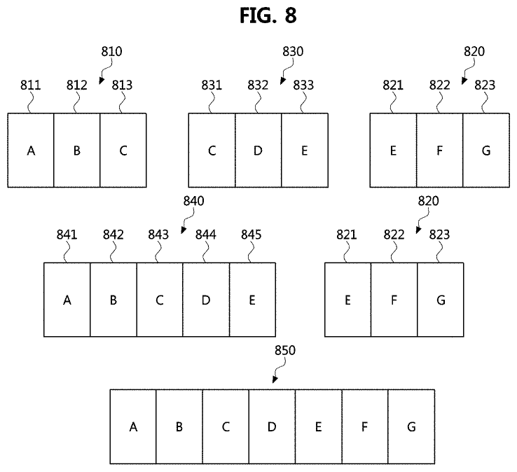

FIG. 8 is a conceptual diagram illustrating one example embodiment of a first image, a second image, a third image, and a stitched image.

Referring to FIG. 8, the terminal may stitch the third image onto a first stitching region of the first image and stitch the remaining regions of the third image excluding a region corresponding to a second stitching region onto the first image to generate a stitched image (S560). The image generated by the terminal by stitching the first image, and the third image may be defined as a first stitched image 840.

Further, the terminal may set a preset range of one end of the first stitched image 840 as a third stitching region 845 (S570). The third stitching region 845 may be located at one end on the right side of the first stitched image 840. The third stitching region 845 of the first stitched image 840 may include a plurality of pixels. In addition, a second image 820 may include a region corresponding to the third stitching region 845 of the first stitched image 840. The region corresponding to the third stitching region 845 may be located at one end 821 on the left side of the second image. The region, which is included in the second image 820 and corresponds to the third stitching region 845, may be defined as a fourth stitching region 821. The fourth stitching region 821 of the second image 820 may include a plurality of pixels and may have the same number of pixels as pixels included in the third stitching region 845 of the first stitched image 840.

In order to search for the fourth stitching region 821 from the corrected second image 820, the terminal may search for a region in which the ratio of pixels corresponding to color information of the pixels included in the third stitching region 845 exceeds a preset range. Alternatively, in order to search for the region corresponding to the third stitching region 845 from the corrected second image 820, the terminal may search for a region including pixels having color information whose error rate does not exceed a preset range (S580).

The terminal may further stitch the second image 820 onto the first stitched image 840 generated from a first image 810 and a third image 830 (S590). Specifically, the terminal may stitch the second image 820 onto the third stitching region 845, and the remaining regions 822 and 823 of the second image 820 excluding the region corresponding to the fourth stitching region 821 may be stitched onto the first stitched image 840 to generate a second stitched image 850 (S590).

According to the present invention, an image stitching method of the present invention can smoothly stitch a plurality of images by stitching the images based on color information of images corrected based on luminance information of pixels included in the images.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. A method of operating a terminal performing image stitching to generate a virtual reality (VR) image inside a vehicle, the method comprising:
obtaining a plurality of images including a first image and a second image;
generating a corrected first image and a corrected second image based on the first image and the second image;
setting a stitching region, which is a preset region and includes a plurality of pixels, in the corrected first image and obtaining information on the plurality of pixels included in the stitching region;
searching a region corresponding to the stitching region from the corrected second image based on the information on the plurality of pixels included in the stitching region; and
stitching a region of the corrected second image excluding the corresponding region onto the corrected first image.

2. The method of claim 1, wherein
the plurality of images are images captured by a fisheye lens, and
the generating of the corrected first image and the corrected second image includes correcting color information of pixels included in the first image and the second image.

3. The method of claim 1, wherein the searching of the region corresponding to the stitching region from the corrected second image includes searching for a region in which a ratio of pixels corresponding to color information of the pixels included in the stitching region exceeds a preset range from the corrected second image.

4. The method of claim 1, wherein the searching of the region corresponding to the stitching region from the corrected second image includes searching for a region, which includes pixels having color information whose error rate does not exceed a preset range as compared with the pixels included in the preset region of the first image, from the corrected second image.

5. The method of claim 4, further comprising:
after the searching of the region corresponding to the stitching region from the corrected second image,
calculating an average of error rates between the color information of the pixels included in the preset region of the first image and color information of pixels included in a region of the second image to be overlapped; and
correcting a color of the second image based on the average value of the error rates.

6. The method of claim 1, further comprising:
when the corresponding region is not searched in the searching of the region corresponding to the stitching region from the corrected second image,
obtaining a third image;
generating a corrected third image based on the third image;
searching a region corresponding to the stitching region from the corrected third image based on pixel information on the preset region of the corrected first image; and
stitching a region of the corrected third image excluding the corresponding region onto the corrected first image.

7. The method of claim 6, wherein the third image is an image captured at a position between a position of a camera at which the first image is captured and a position of a camera at which the second image is captured.

8. A terminal for performing image stitching to generate a virtual reality (VR) image inside a vehicle, the terminal comprising:
a processor; and
a memory in which at least one command to be executed by the processor is stored,
wherein the at least one command is executed to:
obtain a plurality of images including a first image and a second image;
generate a corrected first image and a corrected second image based on the first image and the second image;
set a stitching region, which is a preset region and includes a plurality of pixels, in the corrected first image;
obtain information on the plurality of pixels included in the stitching region;
search for a region corresponding to the stitching region from the corrected second image based on the information on the plurality of pixels included in the stitching region; and
stitch a region of the corrected second image, which excludes the corresponding region, onto the corrected first image.

9. The terminal of claim 8, wherein
the plurality of images are images captured by a fisheye lens, and
the at least one command is further executed to correct colors of pixels included in the first image and the second image.

10. The terminal of claim 8, wherein the at least one command is executed to search for a region in which a ratio of pixels corresponding to color information of the pixels included in the stitching region exceeds a preset range from the corrected second image.

11. The terminal of claim 8, wherein the at least one command is executed to search for a region, which includes pixels having color information whose error rate does not exceed a preset range as compared with the pixels included in the preset region of the first image, from the corrected second image.

12. The terminal of claim 11, wherein the at least one command is further executed to:
after being executed to search for the region corresponding to the stitching region from the corrected second image,
calculate an average of error rates between the color information of the pixels included in the preset region of the first image and color information of pixels included in a region of the second image to be overlapped; and
correct a color of the second image based on the average of the error rates.

13. The terminal of claim 11, wherein the at least one command is further executed to:
when the corresponding region is not searched from the corrected second image,
obtain a third image;
generate a corrected third image based on the third image;
search for a region corresponding to the stitching region from the corrected third image based on pixel information of the preset region of the corrected first image; and
stitch a region of the corrected third image excluding the corresponding region onto the corrected first image.

14. The terminal of claim 13, wherein the third image is an image captured at a position between a position of a camera at which the first image is captured and a position of a camera at which the second image is captured.
